(19) United States
(12) Patent Application Publication
(10) Pub. No.: US 2002/0111974 A1
(43) Pub. Date: Aug. 15, 2002

(54) Method and apparatus for early presentation of emphasized regions in a web page

(75) Inventors: Rabindranath Dutta, Austin, TX (US); Karthikeyan Ramamoorthy, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/784,590

(22) Filed: Feb. 15, 2001

(51) Int. Cl. G06F 17/22; G06F 17/21

(52) U.S. Cl. 707/526; 707/513

(57) ABSTRACT

A method, apparatus, and computer implemented instructions for audibly presenting a document in a data processing system. The document is parsed to identify a presence of a selected tag, wherein text is associated with the selected tag. Responsive to an identification of the presence of the selected tag, the text is audibly presented prior to presenting other text within the document.

### BACKGROUND OF THE INVENTION

1. Technical Field

The present invention generally relates generally to an improved data processing system, and in particular to a method and apparatus for presenting selected regions in a web page.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Vision impaired users of web often rely on tools, such as a talking web browser. An example of a talking web browser is the Home Page Reader (HPR), which is available from International Business Machines Corporation (IBM). HPR is a spoken on-ramp to the Information Highway for computer users who are blind or visually impaired. HPR provides web access by quickly, easily, and efficiently speaking web page information. HPR provides a simple, easy-to-use interface for navigating and manipulating Web page elements. Using the keyboard to navigate, a user who is blind or who has a visual impairment can hear the full range of web page content provided in a logical, clear, and understandable manner.

In perceptual psychology, a notion of gestaltic comprehension is present in which the perception is manifested by understanding the whole rather than analyzing small parts and combining them. For example, when a user views a Web page, a quick glance is all that it takes for the user to decide whether to read the web page. Often the quick glance is focused on the icons and/or pictures and some heavily enlarged or bolded headlines in the web page. Unfortunately, with users who are blind, the gestaltic perception of the web page is more difficult. Part of this difficulty occurs because speech is more sequential than vision.

The present invention recognizes that one problem with talking web browsers is that an overview of a page is unavailable because this type of web browser moves from topic to topic in a sequential manner. Therefore, it would be advantageous to have an improved method and apparatus for presenting a web page to a user who may be visually impaired.

### SUMMARY OF THE INVENTION

The present invention provides a method, apparatus, and computer implemented instructions for audibly presenting a document in a data processing system. The document is parsed to identify a presence of a selected tag, wherein text is associated with the selected tag. Responsive to an identification of the presence of the selected tag, the text is audibly presented prior to presenting other text within the document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram of a browser program in accordance with a preferred embodiment of the present invention;

FIG. 4 is a diagram of a web page that may be presented in accordance with a preferred embodiment of the present invention;

FIG. 5 is a diagram illustrating examples of tags used to identify an emphasis for text in a web page in accordance with a preferred embodiment of the present invention;

FIG. 6 is a diagram of a web page received by a browser prior to presentation in accordance with a preferred embodiment of the present invention;

FIG. 7 is a diagram of a list used to present text in accordance with a preferred embodiment of the present invention;

FIG. 8 is a flowchart of a process used for processing a web page in accordance with a preferred embodiment of the present invention; and

FIG. 9 is a flowchart of a process used for presenting text in a list in accordance with a preferred embodiment of the present invention.

### DETAILED DESCRIPTION OF THE PREFERRED EMBODIMENT

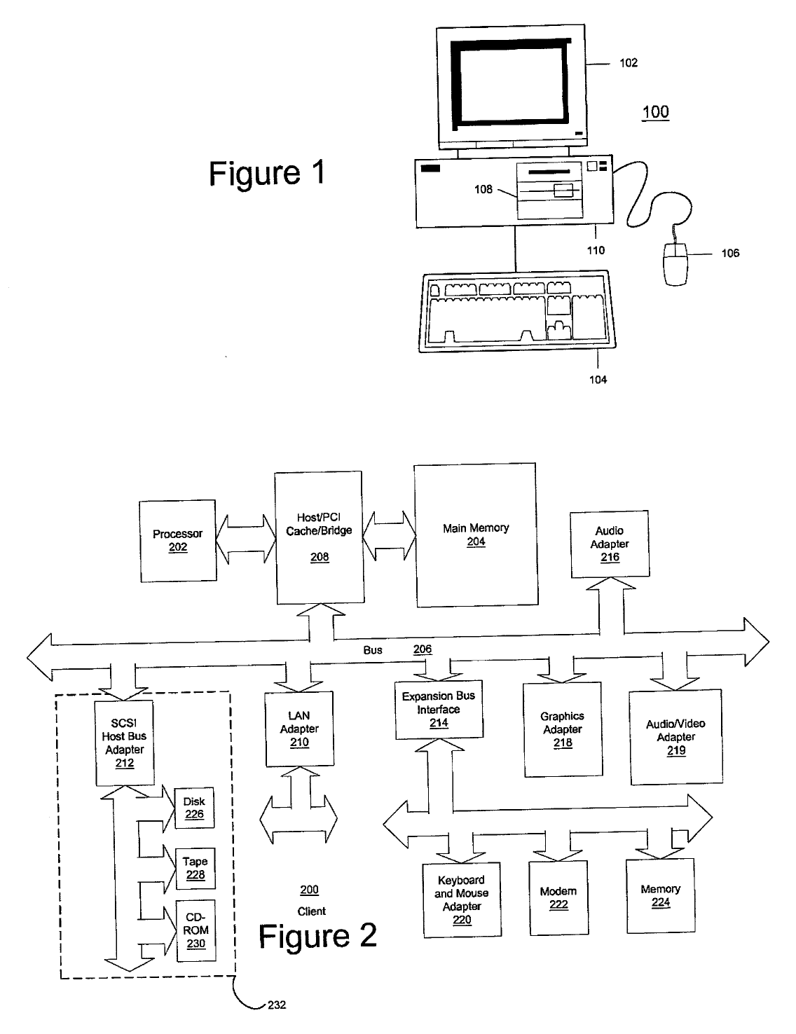

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

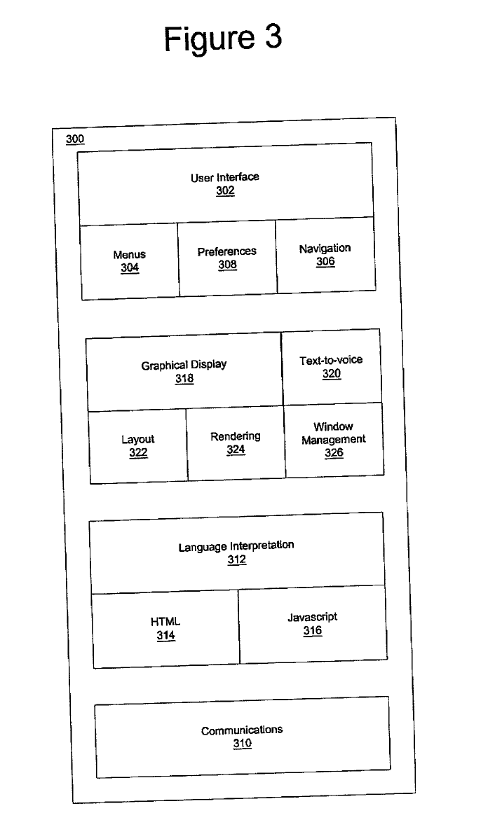

Turning next to FIG. 3, a block diagram of a browser program is depicted in accordance with a preferred embodiment of the present invention. A browser is an application used to navigate or view information or data in a distributed database, such as the Internet or the World Wide Web.

In this example, browser 300 is a talking web browser, which may be implemented using the Home Page Reader HPR, which is available from International Business Machines Corporation (IBM). The processes of the present invention may be implemented within HPR.

As illustrated, browser 300 includes a user interface 302, which includes both a graphical user interface (GUI) and a “visually impaired interface”. The GUI allows a normal user to interface or communicate with browser 300, while the visually impaired interface provides a means for a visually handicapped user to navigate a web page. This visually impaired interface includes an interface that will recognize voice commands as well as commands input from a keyboard. This interface provides for selection of various functions through menus 304 and allows for navigation through navigation 306. For example, menu 304 may allow a user to perform various functions, such as saving a file, opening a new window, displaying a history, and entering a URL. Navigation 306 allows for a user to navigate various pages and to select web sites for viewing. For example, navigation 306 may allow a user to see a previous page or a subsequent page relative to the present page. Preferences such as those illustrated in FIG. 3 may be set through preferences 308.

Communications 310 is the mechanism with which browser 300 receives documents and other resources from a network such as the Internet. Further, communications 310 is used to send or upload documents and resources onto a network. In the depicted example, communication 310 uses HTTP. Other protocols may be used depending on the implementation. Documents that are received by browser 300 are processed by language interpretation 312, which includes an HTML unit 314 and a JavaScript unit 316. Language interpretation 312 will process a document for presentation on graphical display 318, as well as through text-to-voice unit 320 for visually impaired users. In particular, HTML statements are processed by HTML unit 314 for presentation while JavaScript statements are processed by JavaScript unit 316. The processes of the present invention may be implemented within language interpretation 312 to identify tags having selected types of emphasis for early presentation for visually impaired users.

Graphical display 318 includes layout unit 322, rendering unit 324, and window management 326. These units are involved in presenting web pages to a user based on results from language interpretation 312.

Browser 300 is presented as an example of a browser program in which the present invention may be embodied. In this example, browser 300 may be used by both normal and visually impaired users. Browser 300 is not meant to imply architectural limitations to the present invention. Presently available browsers may include additional functions not shown or may omit functions shown in browser 300. A browser may be any application that is used to search for and present content on a distributed data processing system. Browser 300 may be implemented using known browser applications, such Netscape Navigator, Microsoft Internet Explorer, and Home Page Reader. Netscape Navigator is available from Netscape Communications Corporation while Microsoft Internet Explorer is available from Microsoft Corporation.

Browser 300 will parse a web page to create a list of words from emphasized regions in the web page. This list will be presented to the user prior to the rest of the web page being presented to the user. The text within the list provides a quick overview of the web page.

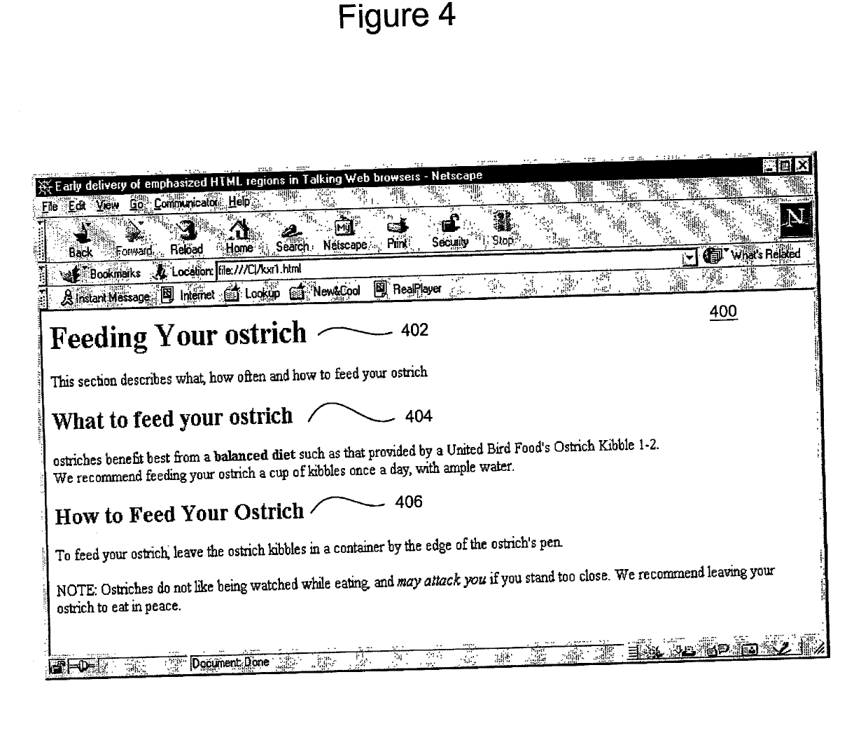

With reference now to FIG. 4, a diagram of a web page that may be presented is depicted in accordance with a preferred embodiment of the present invention. Web page 400 is an example of a visually presented web page in which some text has more emphasis that other text. For example, line 402 provides the most emphasis with line 404 and 406 providing the next level of emphasis. In presenting web page 400 to a visually impaired user, browser 300 in FIG. 3 would initially read “Feeding Your Ostrich” in line 402 to the user in a first level of emphasis. Next, the text “What to feed your ostrich” in line 404 and the text “How to Feed Your Ostrich” in line 406 would be presented with a second level of emphasis. In this example, the second level of emphasis is less than the first level of emphasis. The level of emphasis, also referred to as an emphasis level, may be embodied using different factors. For example, the volume of the voice, the intonation of the voice, and the speed of presentation may be varied to change the level of emphasis. After these lines have been presented, then the user may select other regions associated with these lines for presentation. In this manner, the user is able to obtain an overview of the web page. In this example, the web page is an hypertext markup language (HTML) document. Of course the mechanism of the present invention may be applied to other types of documents, such as other markup language documents like extensible markup language (XML) documents.

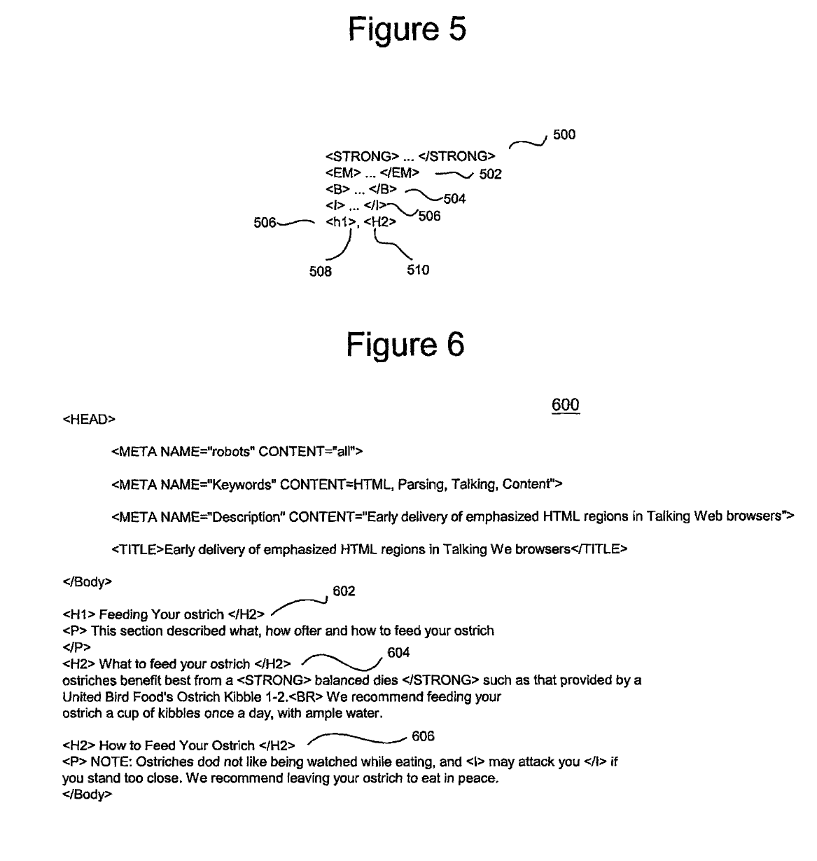

Turning next to FIG. 5, a diagram illustrating examples of tags used to identify an emphasis for text in a web page is depicted in accordance with a preferred embodiment of the present invention. Tag pairs 500, 502, 504, and 506 are examples of tag pairs identified as encompassing text that is to be presented to a user to provide an overview of a document. Depending on the type of tag in the tag pair, a different emphasis level may be assigned to the text associated with the tag pair. For example, text associated with tag pair 506 may be presented using a higher emphasis level than text associated with tag pair 502. Tag 508 is the opening tag in tag pair 506, while tag 510 is the closing tag in tag pair 506. Although tags are used in these examples to associate emphasis levels other mechanisms also may be used.

Turning now to FIG. 6, a diagram of a web page received by a browser prior to presentation is depicted in accordance with a preferred embodiment of the present invention. Web page 600 is an example of web page 400 in FIG. 4 prior to presentation on a display by a browser, such as browser 300 in FIG. 3. In this example, lines 602, 604, and 606 are audibly presented to the user prior to other portions being presented to the user. In the depicted examples, lines 602 includes the tags “<H1></H2>”. Line 604 includes the tags “<H2> </H2>”, while line 606 contains the tags “<H2> </H2>”. Based on the tags, the text associated with line 602 is provided more emphasis than text associated with line 604 and line 606.

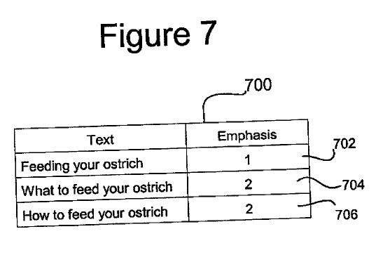

With reference now to FIG. 7, a diagram of a list used to present text is depicted in accordance with a preferred embodiment of the present invention. List 700 contains entries 702, 704, and 706. These entries correspond to the text in web page 400 in FIG. 4 and web page 600 in FIG. 6, which are audibly presented to a user. Each entry includes text and an emphasis level that is to be used to present the text in the entry. Although in the depicted examples, text is placed in a list in association with emphasis levels, other data structures may be used other than a list. For example, the text and associated emphasis levels may be stored in a database.

Each time the mechanism of the present invention identifies a selected tag that is to be presented, the text associated with that tag is placed in list 700. In these examples, the selected tag is a particular opening tag for text. The opening tag is the first tag in a pair of tags encountered in association with text. The amount of text that is to be placed in the list is defined by the closing tag, which is the tag appearing at the end of the text in association with the opening tag. Further, although the emphasis levels are ranked by numbers, any other mechanism for ordering emphasis levels may be used.

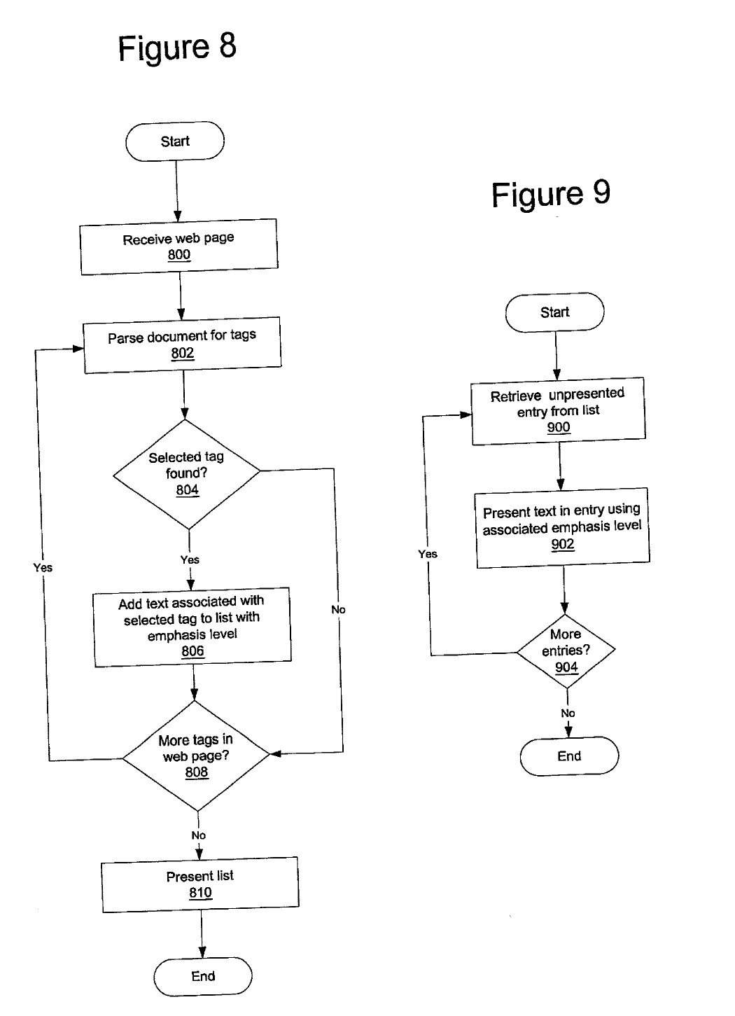

Turning now to FIG. 8, a flowchart of a process used for processing a web page is depicted in accordance with a preferred embodiment of the present invention. The process illustrated in FIG. 8 may be implemented in a browser, such a browser 300 in FIG. 3.

The process begins by receiving a web page (step 800). The web page is then parsed for tags (step 802). Next, a determination is made as to whether a selected tag has been found (step 804). The type of tag that identifies text for early presentation may differ depending on the particular implementation. The selected tag may include those found such as those found in FIG. 5. If the selected tag is found, the text associated with the selected tag is added to the list with an emphasis level (step 806). This list may be implemented using list 700 in FIG. 7. In the depicted examples, the selected tag in an opening tag in a tag pair. The text associate with the selected tag is identified as the text between the selected tag and the closing tag in the tag pair.

A determination is then made as to whether there are more tags in the document (step 808). If additional tags are absent, the list is presented to the user (step 810) with the process terminating thereafter. Otherwise, the process returns to step 802 as described above.

With reference again to step 804, if the selected tag is not found, the process proceeds to step 808 as described above.

Turning next to FIG. 9, a flowchart of a process used for presenting text in a list is depicted in accordance with a preferred embodiment of the present invention. The process illustrated in FIG. 9 is a more detailed description of step 810 in FIG. 8.

The process begins by retrieving an unpresented entry from a list (step 900). The list may be implemented using a list similar to list 700 in FIG. 7. The text in the entry is then presented using an associated emphasis level (step 902). Next, a determination is made as to whether there are more entries are present in the list (step 904). If additional entries are not present within the list, the process terminates. Otherwise the process returns to step 900 as illustrated above.

Thus, the present invention provides a method, apparatus, and computer implemented instructions for early delivery of selected regions in a web page to a user. The mechanism of the present invention identifies text with an emphasis for early presentation based on the type of tag in the web page. When the entire web page has been processed, the text in the list is then audibly presented to the user. In this manner, an overview of a web page is provided to a visually impaired user. For example, the text could be presented in braille to the user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, rather than placing the text in a list, the text could be presented as encountered within the web page. Further, the mechanism of the present invention may be applied to other types of documents other than a web page. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for audibly presenting a document, the method comprising:
parsing the document to identify a presence of a selected tag indicating an emphasis level, wherein text is associated with the selected tag; and
responsive to an identification of the presence of the selected tag, audibly presenting the text using the emphasis level prior to presenting other text within the document.

2. The method of claim 1, wherein the document is a markup language document.

3. The method of claim 2, wherein the markup language document is one of a hypertext markup language document and a extensible markup language document.

4. The method of claim 1, wherein the document is a web page.

5. The method of claim 4, wherein the selected level of emphasis is selected based on a type for the selected tag.

6. The method of claim 1, wherein the method is located in a web browser.

7. A method in a data processing system for presenting a document, the method comprising:
receiving the document;
parsing the document to identifying a present of a selected tag, wherein a set of text is associated with the selected tag;
responsive each selected tag identified to form an identified tag, placing the set of text in a data structure;
responsive to placing the set of text in the data structure, associating an emphasis level with the set of text; and
responsive to a completion of parsing the document, presenting each set of text in the data structure using an associated emphasis level.

8. The method of claim 8, wherein the data structure is on of a list, a linked list, and a database.

9. The method of claim 8, wherein the set of text is at least one word.

10. The method of claim 8, wherein the emphasis level is at least one of a volume level and a type of intonation.

11. The method of claim 8, wherein the text in the data structure is presented prior to presenting other text in the document.

12. The method of claim 8, wherein the text is presented audibly.

13. The method of claim 8, wherein the method is located in a web browser.

14. The method of claim 8, wherein the document is a markup language document.

15. The method of claim 15, wherein the markup language document is one of a hypertext markup language document and a extensible markup language document.

16. The method of claim 8, wherein the document is a web page.

17. A data processing system for audibly presenting a document, the data processing system comprising:
parsing means for parsing the document to identify a presence of a selected tag indicating an emphasis level, wherein text is associated with the selected tag; and
audibly presenting means, responsive to an identification of the presence of the selected tag, for audibly presenting the text using the emphasis level prior to presenting other text within the document.

18. The data processing system of claim 18, wherein the document is a markup language document.

19. The data processing system of claim 19, wherein the markup language document is one of a hypertext markup language document and an extensible markup language document.

20. The data processing system of claim 18, wherein the document is a web page.

21. The data processing system of claim 18, wherein the selected level of emphasis is selected based on a type for the selected tag.

22. The data processing system of claim 18, wherein the parsing means and audibly presenting means are located in a web browser within the data processing system.

23. A data processing system for presenting a document, the data processing system comprising:
receiving means for receiving the document;
parsing means for parsing the document to identifying a present of a selected tag, wherein a set of text is associated with the selected tag;
placing means, responsive each selected tag identified to form an identified tag, for placing the set of text in a data structure;
associating means, responsive to placing the set of text in the data structure, for associating an emphasis level with the set of text;
presenting means, responsive to a completion of parsing the document, for presenting each set of text in the data structure using an associated emphasis level.

24. The data processing system of claim 25, wherein the data structure is on of a list, a linked list, and a database.

25. The data processing system of claim 25, wherein the set of text is at least one word.

26. The data processing system of claim 25, wherein the emphasis level is at least one of a volume level and a type of intonation.

27. The data processing system of claim 25, wherein the text in the data structure is presented prior to presenting other text in the document.

28. The data processing system of claim 25, wherein the text is presented audibly.

29. The data processing system of claim 25, wherein the receiving means, parsing means, placing means, associating means, and presenting means are located in a web browser within the data processing system.

30. The data processing system of claim 25, wherein the document is a markup language document.

31. The data processing system of claim 32, wherein the markup language document is one of a hypertext markup language document and a extensible markup language document.

32. The data processing system method of claim 25, wherein the document is a web page.

33. A data processing system comprising:
a bus system;
a communications unit connected to the bus system;
a memory connected to the bus system, wherein the memory includes as set of instructions; and
a processing unit connected to the bus system, wherein the processing unit executes the set of instructions to parse the document to identifying a presence of a selected tag indicating an emphasis level, wherein text is associated with the selected tag; and audibly present the text using the emphasis level prior to presenting other text within the document in response to an identification of the presence of the selected tag.

34. The data processing system of claim 35, wherein the bus system is a single bus.

35. The data processing system of claim 35, wherein the bus system includes a primary bus and a secondary bus.

36. The data processing system of claim 35, wherein the processing unit includes a plurality of processors.

37. The data processing system of claim 35, wherein the communications unit is one of a modem and Ethernet adapter.

38. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a document; parse the document to identifying a present of a selected tag, wherein a set of text is associated with the selected tag; place the set of text in a data structure in response each selected tag identified to form an identified tag; associate an emphasis level with the set of text in response to placing the set of text in the data structure; present each set of text in data structure using an associated emphasis level in response to a completion of parsing the document.

39. A computer program product in a computer readable medium for audibly presenting a document, the computer program product comprising:
first instructions for parsing the document to identifying a presence of a selected tag indicating an emphasis level, wherein text is associated with the selected tag;
second instructions, responsive to an identification of the presence of the selected tag, for audibly presenting the text using the emphasis level prior to presenting other text within the document.

40. A computer program product in a computer readable medium for presenting a document, the computer program product comprising:
first instructions for receiving the document;
second instructions for parsing the document to identifying a present of a selected tag, wherein a set of text is associated with the selected tag;
third instructions, responsive each selected tag identified to form an identified tag, for placing the set of text in a data structure;
fourth instructions, responsive to placing the set of text in the data structure, for associating an emphasis level with the set of text; and
fifth instructions, responsive to a completion of parsing the document, for presenting each set of text in data structure using an associated emphasis level.
